(19) United States
(12) Patent Application Publication
(10) Pub. No.: US 2024/0144192 A1
(43) Pub. Date: May 2, 2024

(54) USING LARGE LANGUAGE MODEL IN REDUCING EXTENT OF CALENDAR RELATED INTERACTION

(71) Applicant: GOOGLE LLC, Mountain View, CA (US)

(72) Inventors: Felix Weissenberger, Zurich (CH); Eric Stavarache, Zurich (CH); Henry Dlhopolsky, Zurich (CH)

(21) Appl. No.: 17/978,437

(22) Filed: Nov. 1, 2022

(51) Int. Cl. G06Q 10/10; G06F 3/0482; G06F 40/166; G06F 40/35; G06F 40/40

(52) U.S. Cl. CPC G06Q 10/1093; G06F 3/0482; G06F 40/166; G06F 40/35; G06F 40/40

(57) ABSTRACT

Some implementations process structured calendar data of an electronic calendar for a first user, to generate a natural language representation of the structured calendar data. Versions of those implementations further, in response to receiving a query determined to be relevant to the electronic calendar, prime a large language model (LLM) using a priming input (e.g., process the priming input using the LLM), where the priming input is based on the natural language representation of the structured calendar data. Following priming of the LLM using the priming input, some of those versions process, using the LLM, query input that is based on the query, to generate a LLM output and determine, based on the LLM output, a response to the query. The response can include a natural language response that can be rendered.

### BACKGROUND

In electronic communications where a user receives or sends emails and/or messages, or makes a call, the user is often requested to provide (or to confirm) their availability during a particular time period of a particular day, for an event such as a training session, an appointment, an office meeting, a holiday party, a get-together with friend, or a dinner at a restaurant. For example, the user may receive an email that asks “Are you free next Thursday for a meeting?” To confirm availability and/or to reply with one or more preferred time slots, the user may need to check his or her calendar(s) to see whether anything has been scheduled for next Thursday. As another example, as a close friend of Sarah, a user may be asked “When is Sarah's birthday” during a call, but despite vaguely remembering that Sarah's birthday is in May, the user may not be very sure whether it's exactly May 18th or May 19th. In this example, the user may check his or her calendar to see whether a date is marked for Sarah's birthday, or in case there are old messages showing previous communications for a birthday party planned for Sarah last year, the user may look up the old messages.

In these and other examples, the user cannot formulate an instant reply without accurate availability information to help schedule an event. As a result, a response of the user will be delayed until they have gathered desired information by searching through calendar(s) and/or messages that contain calendar data. In addition to the delay in the reply, significant resources, of a client device of the user, will be consumed in gathering the necessary information. For example, battery resources of the client device can be consumed while the user is searching and/or viewing necessary information, processor resources of the client device resources can be consumed in searching for and/or rendering the necessary information, etc. Further, in these and other examples, when a requesting user is attempting to schedule a meeting with a receiving user or otherwise inquire about a receiving user's calendar, the receiving user (or a third-party acting on the receiving user's behalf) must utilize client device resources in formulating a reply to the requesting user.

### SUMMARY

Implementations disclosed herein relate to using a large language model (LLM), to respond to a query related to electronic calendar(s) of user(s), after first priming the LLM using calendar data (structured or unstructured) associated with at least one of the user(s). For example, the response to the query can be generated based on output from the LLM, after the LLM is primed using the calendar data and then the query is processed using the primed LLM. Some of those implementations generate a natural language representation of the calendar data and prime the LLM based on the natural language representation.

Some implementations disclosed herein additionally or alternatively relate to receiving one or more messages (text or audio) and determining whether the one or more messages include a query that is relevant to electronic calendar(s) (e.g., calendar(s) of the user who created the message(s) and/or calendar(s) of the user(s) to which the message(s) are directed). When a query is determined to be relevant to electronic calendar(s), the query can be processed using the LLM, after first priming the LLM with calendar data from the electronic calendar(s). Further, a response to the query can be generated based on LLM output that is generated after processing of the query. For example, the LLM output can include a probability distribution over words, word pieces, and/or action(s) (e.g., remote procedure call(s) RPC(s)) and the response can be generated based on the probability distribution. The response can be visually and/or audibly rendered, to the user who created the message or user(s) to which the message is directed. For example, the response can be rendered to the user who created the message, without requiring any input from a receiving user to whom the query is directed, thereby obviating any use by the receiving user of their client device to formulate a response—and thereby conserving resources of their client device. As another example, the response can be rendered as a selectable suggested reply to a receiving user to whom the query is directed and, if selected (e.g., via a single tap or other single input), can be sent as a reply to the query. This can obviate any use, by the receiving user, of their client device to consult a calendar application and formulate a response—thereby conserving resources of their client device.

Various implementations disclosed herein relate to retrieving and processing structured calendar data (e.g., a calendar entry, sometimes also referred to as “entry” or “entry of a calendar”) of an electronic calendar to generate a natural language representation that is used to prime an LLM as described herein. For example, a client device (or a remote server) can access an electronic calendar for one or more calendar entries (e.g., entries within a designated month from a designated user's working calendar) and process the one or more calendar entries to generate a natural language representation for the one or more calendar entries.

In some implementations or situations, the client device can process the entire electronic calendar to generate an entire natural language representation of the entire electronic calendar. In some other implementations or situations, the client device can process entries of the electronic calendar within a selected date range, to generate a natural language representation of the entries of the electronic calendar within the selected date range. In some of those implementations, the selected date range is selected based on a query for which the calendar data is being processed. For example, only Bob's calendar data for “next week” can be processed responsive to a query, from Sue, of “Does Bob have 30 minutes for a meeting next week to discuss project X”, whereas Bob's calendar for the next three weeks (or other default time period) can be processed responsive to a query, from Sue, of “Find 30 minutes for a meeting with Bob to discuss project X” that does not specify a time period for the meeting. Optionally, the client device can process each entry within the selected date range respectively, to generate a corresponding natural language representation. The corresponding natural language representations can optionally be combined (e.g., sequentially) to form a single natural language representation.

Various implementations disclosed herein relate to receiving one or more messages (text, graphic, animated, or audio) and determining whether the one or more messages include a query that is relevant to an electronic calendar. For example, the client device can, with appropriate permissions, at least selectively monitor (e.g., via an automated assistant) one or more applications (e.g., messaging application, and/or social media application) for electronic communications (e.g., messages, files, screenshot), and determine (for example, in real time) whether a query is detected from the electronic communications. The client device (or the remote server) can directly determine whether a query that is relevant to an electronic calendar is detected from the electronic communications. To reduce or save computing resources, the client device can first determine whether a query is detected from the electronic communications, and if a query is detected, the client device can further determine whether such query is relevant to an electronic calendar accessible by the client device (or by the remote server with which the client device communicates). Determining whether a query is relevant to (or sometimes, directed to) an electronic calendar can be performed using one or more machine learning models trained on one or more keywords (e.g., temporal terms) or one or more sentence structures, and/or can be performed using other techniques or processes. Optionally, for an electronic calendar that the client device cannot access, in some cases, the client device can generate a request to access the electronic calendar and send the request to an administrator (be it an owner of the electronic calendar, or someone authorized to manage the electronic calendar) for permission to access the electronic calendar.

Various implementations disclosed herein relate to generating a natural language representation, for structured calendar data of an electronic calendar, in advance of using the natural language representation in priming an LLM and then processing a received query using the primed LLM. Generating the natural language representation in advance can mitigate latency in processing the received query using the primed LLM, as the natural language representation is already generated and can be used immediately in priming the LLM in advance of processing the query. Optionally, in response to receiving a query subsequent to the generation of the natural language representation for the structured calendar data of the electronic calendar, the client device (or remote server) can determine whether the electronic calendar is updated with additional structured calendar data after the generation of the natural language representation for the structured calendar data but before priming the LLM. If the electronic calendar is determined to be updated with the additional structured calendar data, the client device (or remote server) can generate an updated natural language representation for the structured calendar data (including the additional structured calendar data) of the electronic calendar, so that the natural language representation used to prime the LLM is up to date. However, if the electronic calendar is determined to not have been updated, the previously generated natural language representation can be used in priming the LLM. In these and other manners, reduced latency from pre-generation of the natural language representation can be at least selectively achieved (e.g., when it is determined that the electronic calendar has not been updated since generating the natural language representation), while still enabling selective updating of the natural language representation and improved generation of output as a result of the updating of the natural language representation. It is noted that determining whether the electronic calendar is updated with additional structured calendar data can be performed with less latency than generating the natural language representation.

In some implementations, priming a LLM using the natural language representation for the structured calendar data can include: generating a priming input based on the natural language representation for the structured calendar data and processing the priming input using the LLM, where the priming input is used as an input for the LLM. An intermediary output of the LLM can be generated based on processing the priming input, but optionally will not be utilized directly in generating a response as described herein. Rather, the intermediary output can be further processed using the LLM model. However, only the LLM output generated after processing the query, using the primed LLM, can be used in generating a response. As a non-limiting example, the priming input can include only the structured calendar data. For example, the structured calendar data can include an electronic calendar, a portion of an electronic calendar despite such portion including no calendar entries, one or more entries of the calendar, a column in a table characterizing a calendar where the column reflects calendar entries on a particular day, and/or a table reflecting calendar entries for a whole week, etc. Alternatively, the priming input can include only the natural language representation for the structured calendar data (e.g., May 25, 2015 is Memorial Day, a federal holiday). Alternatively, the priming input can include the structured calendar data, in addition to or in lieu of the natural language representation for the structured calendar data.

Alternatively or additionally, the priming input can include unstructured data. For example, the priming input can include the structured calendar data, and/or the unstructured data. As another example, the priming input can include the natural language representation for the structured calendar data, and/or the unstructured data. As a further example, the priming input can include the structured calendar data, the natural language representation for the structured calendar data, and/or the unstructured data. The unstructured data can indicate a user's activity, preference, availability, relationship, or planning, etc. The unstructured data can be from an electronic calendar, or can from any other available sources such as a text message (that, for example, confirms an online restaurant order ready to pick up at 11:45 am), an image (that, for example, titled Sarah's birthday party and dated May 18, 2020), an email (that, for example, contains an electronic receipt showing the booking of a movie ticket), or a trip-planning application (that, for example, shows an upcoming itinerary). When the unstructured data is from an electronic calendar, or is stored as part of metadata for an electronic calendar (but not stored in a structured data structure, such as a table, matrix, one or more entries having a fixed format, etc., of the electronic calendar), such unstructured data can be referred to as “unstructured calendar data”.

As a non-limiting example, the unstructured data can be or can include: (1) a message (e.g., “doctor appointment confirmed for this Wednesday 4 pm”, “Ben leaves work for vacation the first week of June every year”, etc.) or a conversational history containing the message, a piece of information from a diary (e.g., “Kim is going to Alaska next February”), (2) post content (e.g., “Me in Pittsburgh now visiting family) showing activity information at certain moment(s) or over a certain time period, (3) website page content (e.g., “tickets for pop star A's concert in Seattle will be on sale starting August 8th, 2 pm EST) describing information for an event, that is not stored as structured calendar data in the aforementioned electronic calendar(s) or that is not stored in other structured database(s). Optionally, the message and/or the conversational history here can also be referred to as “unstructured message data”, and the post content here can also be referred to as “unstructured post data”, and the website page content here can also be referred to as “unstructured web content”.

Alternatively or additionally, the unstructured data can also be or include, for example, preference data stored in association with an electronic calendar, while not being stored in one or more entries of the electronic calendar. For example, a user may configure system settings of an electronic calendar to indicates a preference over certain time session(s) for certain activities/events (e.g., CFO prefers meetings at Tuesday 3 pm), and the preference of the user here can be stored in the preference data (referred to as “unstructured calendar data”), as part of metadata for the electronic calendar. It's noted that the preference data does not necessarily need to be data stored in association with an electronic calendar. For example, the preference data can be part of metadata associated with applications (e.g., virtual meeting) other than a calendar application (that provides one or more electronic calendars).

Alternatively or additionally, the unstructured data can also be or include: routine data not created as repeated entries in an electronic calendar, that indicates routine practices of the user. For example, the routine data can be alarm data triggering a wake-up alarm at 7:00 am every workday, or smart device routine data configured to turn off light in an office every 6 pm, etc. Alternatively or additionally, the unstructured data can also include user input, such as a spoken utterance captured by the automated assistant specifying that “I want to set up the meeting this week, if not, next week, but no later than April 30th”, or a conversational history.

Alternatively or additionally, the unstructured data can be or can include: relationship data indicating a relationship between a first user who sends a query (i.e., “requesting user”) and a second user who receives the query (i.e., “receiving user”). For example, the relationship data can indicate that the first user and the second user are co-workers, family members, close friends, infrequent contact, classmates, mentor and mentee, teacher and student, and/or can indicate additional or alternative relationship(s). The relationship data can be retrieved, for example, from a company directory listing names, titles, departments, and contact information of individuals working at the company. Such relationship data can be included in the priming input, along with the structured calendar data (and/or a natural language representation of the structured calendar data). Alternatively, the relationship data can be processed to generate a corresponding natural language representation (e.g., “it is the boss who requests the meeting”, or “the request sender is uncle Bob”), and the priming input can include the natural language representation of the relationship data, instead of (or in addition to) the relationship data itself.

In some implementations, the relationship data may optionally be applied to determine, after a query is determined to be relevant to electronic calendar(s), whether the query needs to be processed (e.g., using the LLM) to generate a response. For example, if the relationship data indicates that the requesting user is not within a network (e.g., network of colleagues, friends, clients, classmates, etc.), a prompt (such as, query from unknown source requesting access to your calendar, do you want to check the sender?) may be generated that needs confirmation or input from the user before the query is processed using the LLM (or even before the LLM is primed using the aforementioned priming input).

Optionally, the priming input can include a first priming input and a second priming input. As a non-limiting example, the first priming input can include the natural language representation for the structured calendar data, and the second priming input can include the structured calendar data itself, without including the natural language representation for the structured calendar data. The present disclosure is not limited thereto. For instance, the first priming input can include the natural language representation for the structured calendar data, and the second priming input can include unstructured data (or a natural language representation of the unstructured data). For instance, the priming input can further include a third priming input, where the first priming input includes the natural language representation for the structured calendar data, the second priming input includes the structured calendar data itself, and the third priming input includes a natural language representation of the unstructured data. Optionally, the first priming input can include the natural language representation for structured calendar data to which a first time range (e.g., next week) corresponds, and the second priming input can include the natural language representation for structured calendar data to which a second time range (e.g., next month) corresponds.

In some implementations, subsequent to priming the LLM using the natural language representation for the structured calendar data, the LLM can be used to process the aforementioned query determined to be relevant to the electronic calendar, to generate a LLM output. Turning to the aforementioned case where the priming input includes a first priming input and a second priming input that is different from the first priming input. The LLM model can first be primed using the first priming input. The query, determined to be relevant to the electronic calendar, can then be processed using the primed LLM (primed using the first priming input) to generate a first LLM output. The LLM model can then be reset and primed using the second priming input, or the LLM model can be primed using the second priming input without being reset. The query can then be processed using the primed LLM (primed using the second priming input) to generate a second LLM output. For example, the first priming input can include a natural language representation (e.g., “next week, Bob is available 2-3 pm on Friday”) of the electronic calendar that corresponds to only week 5, and the second priming input may include a natural language representation (e.g., “next week, Bob is available 2-3 pm on Friday, for the week after next week, Bob is available on Monday 9-10 am but will be away afterwards for the rest of the two weeks”) of the electronic calendar that corresponds to weeks 5 through 7. The first LLM output and the second LLM output can vary, despite being generated based on processing the same query using the LLM. This is due to the first LLM output being generated after priming the LLM with the first priming input and the second LLM output being generated after priming the LLM, alternatively or additionally, with the second priming input.

In the above example, the LLM can be primed with the first priming input, and the LLM primed with the first priming input can be applied to process the query to generate a first LLM output, based on which, a first response (e.g., “invite Bob for a meeting next Friday at 2-3 pm?”) can be generated. Optionally, the first response can be rendered to a user in response to the query (e.g., the user audibly asking the automated assistant, “when is Bob available for a meeting to discuss project X?”), and the user can confirm or select the first response. Optionally, in response to the user confirming or selecting the first response (e.g., “invite Bob for a meeting next Friday at 2-3 pm?”), the automated assistant can generate a link that leads to the creation of a calendar entry for the meeting next Friday at 2-3 pm, or can generate an email containing such link and a description (e.g., “Jerry invites you for a meeting next Friday at 2-3 pm”), where the email is directed or sent to Bob.

Additionally, in the above example where the LLM is to be additionally or alternatively primed with the second priming input, the LLM can be reset (or calibrated) after being primed with the first priming input. The reset LLM can be primed with the second priming input and then process the query to generate a second LLM output, based on which, a second response (e.g., “invite Bob for a meeting next Friday at 2-3 pm, or the week after on Monday 9-10 am?”) can be generated. Optionally, instead of the first response, the second response can be rendered to a user in response to the query (e.g., the user audibly asking the automated assistant, “when is Bob available for a meeting to discuss project X?”), where the second response can include two selectable elements (e.g., a first selectable element corresponding to “next Friday at 2-3 pm” and a second selectable element corresponding to “the week after on Monday 9-10 am”). The user can select one of the two selectable elements, which triggers the generation and/or sending of a link, an invite, or an email containing contents for the selected selectable element. In some implementations, the second response and the first response may be ranked based on one or more ranking factors and the response (e.g., the second response) ranked higher can be rendered to the user for further interaction (user selection, sending over invite/emails, creating calendar entry, etc.). Alternatively, in some situations, the first response and the second response can be rendered simultaneously as separate interactive elements, to be interacted with by the user. Alternatively, in some situations, the first response and the second response can, instead of being rendered directly, be used to generate a final response, where the final response is rendered to a user visually or audibly.

Alternatively, the query determined to be relevant to the electronic calendar may be processed by the LLM that has been primed using the first and second priming input consecutively, to generate a single LLM output. In this case, the LLM may not need to be reset after being primed with the first priming input. That is, the LLM can be primed using the second priming input, directly after being primed with the first priming input. After being primed using both the first and second priming input, the LLM can process the query to generate the single LLM output. Optionally, the first and second priming input may be assigned with different priming weights that impact the single LLM output.

In some implementations, based on the LLM output, a response to the query can be generated based on the LLM output for user interaction, where the response can be rendered visually and/or audibly. Optionally, the response to the query can be modified or altered based on the unstructured data, such as messages or electronic notes, etc.

The above is provided merely as an overview of some implementations. Those and/or other implementations are disclosed in more detail herein.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

The above and other aspects, features, and advantages of certain embodiments of the present disclosure will be more apparent from the following description taken in conjunction with the accompanying drawings. In the drawings:

FIG. 1A and FIG. 1B respectively depicts a block diagram of an example environment that demonstrates various aspects of the present disclosure, and in which implementations disclosed herein may be implemented.

FIG. 2A depicts an example user interface, in accordance with various implementations.

FIG. 2B depicts another example user interface transitioned to from the user interface of FIG. 2A, in accordance with various implementations.

FIG. 3A depicts another example user interface, in accordance with various implementations.

FIG. 3B depicts another example user interface transitioned to from the user interface of FIG. 3A, in accordance with various implementations.

FIG. 3C depicts a further example user interface transitioned to from the user interface of FIG. 3A or FIG. 3B, in accordance with various implementations.

FIG. 4 illustrates a flowchart illustrating an example method for generating an automatic reply in response to a message (or query), in accordance with various implementations.

FIG. 5 is a flowchart illustrating an additional example method for generating an automatic reply in response to a message (or a query), in accordance with various implementations.

FIG. 6 illustrates an example architecture of a computing device, in accordance with various implementations.

FIG. 7 depicts an example of user interaction involving a query relevant to calendar data, in accordance with various implementations;

FIG. 8A, FIG. 8B, and FIG. 8C together depict another example of user interaction involving a query relevant to calendar data, in accordance with various implementations.

### DETAILED DESCRIPTION

The following description with reference to the accompanying drawings is provided for understanding of various implementations of the present disclosure. It's appreciated that different features from different embodiments may be combined with and/or exchanged for one another. In addition, those of ordinary skill in the art will recognize that various changes and modifications of the various embodiments described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

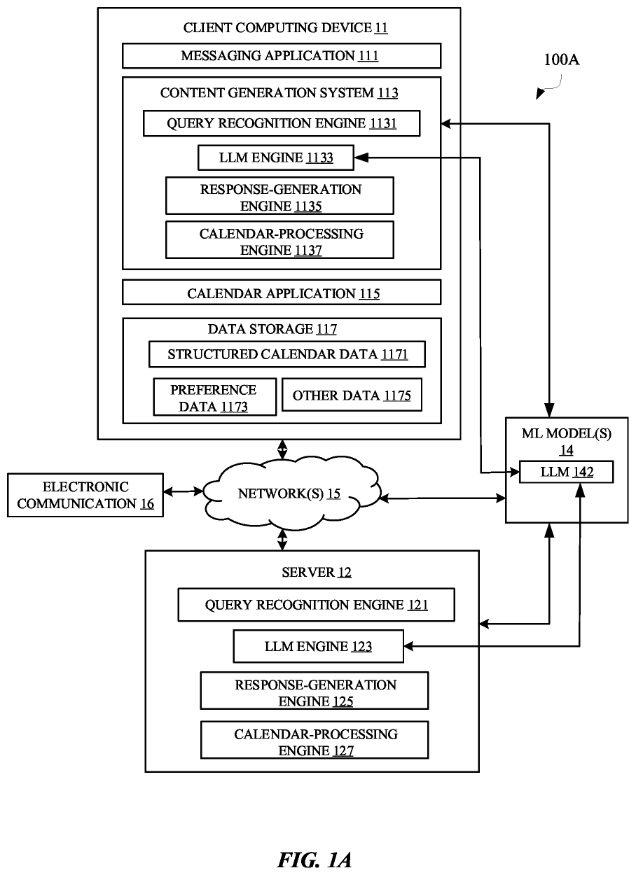

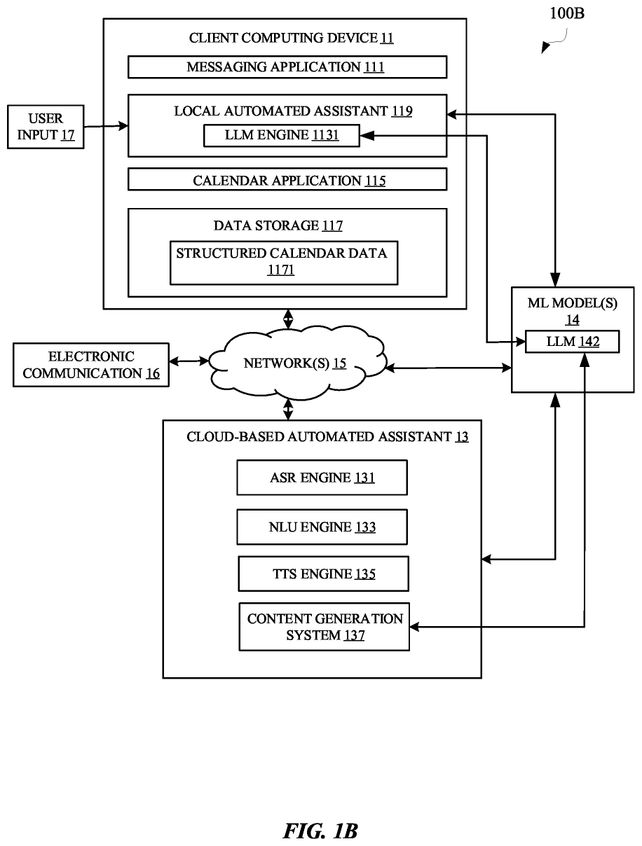

FIG. 1A is a block diagram of an example environment 100A that demonstrates various aspects of the present disclosure, and in which implementations disclosed herein may be implemented. As shown in FIG. 1A, the environment 100A can include a client computing device 11, and a server 12 in communication with the client computing device 11 via one or more networks 15. The client computing device 11 can be, for example, a cell phone, a laptop, a desktop, a notebook computer, a tablet, a smart TV, a messaging device, or a personal digital assistant (PDA), and the present disclosure is not limited thereto. The server computing device 13 can be, for example, a web server, a proxy server, a VPN server, or any other type of server as needed. The one or more networks 15 can include, for example, a local area network (LAN), a wide area network (WAN) such as the Internet, and/or any other appropriate network.

In some implementations, the client computing device 11 can be installed with, or otherwise access, a messaging application 111, where the messaging application 111 can be a test messaging application, an email application, instant messaging application, a social media application, etc. The messaging application 111 can be an application installed locally at the client computing device 11, or can be a web-based application accessible via a web browser of the client computing device 11.

The messaging application 111 can receive one or more messages via electronic communication 16, where the one or more messages can contain a query, such as “Are you free next Thursday?”, “Do you have time tomorrow?”, “When is Sarah's birthday?”, etc. A user of the client computing device 11 can use the messaging application 111 to receive or send one or more messages containing unstructured calendar data, where the unstructured calendar data can be temporal data indicating one's schedule that is not entered as an entry in an electronic calendar. For example, the user can use the messaging application 111 to send a message containing unstructured calendar data, i.e., “Hi Doctor Han, this is to confirm my visit to Eastside animal hospital Friday noon”, for which a corresponding entry is not created in any electronic calendar. As another example, the messaging application 111 can receive an automatic reply message containing unstructured calendar data, i.e., “I am out of office between June 25th and July 5th”, for which a corresponding entry is not created in an electronic calendar accessible via the client computing device 11.

In some implementations, the client computing device 11 can be installed with, or otherwise access, a calendar application 115, where the calendar application can be integrated with the messaging application 111 or can be an individual application separate from the messaging application 111. A user of the client computing device 11 can use the calendar application 115 to access one or more electronic calendars. For example, the user can use the calendar application 115 to access a first electronic calendar of the user for structured calendar data, where the structured calendar data can include one or more entries created in the first electronic calendar for one or more corresponding events which the user is interested in or plans to attend. The one or more entries in the first electronic calendar can include a first entry automatically created by the calendar application 115 in the first electronic calendar for a federal holiday or other well-recognized holiday, and/or a second entry created by the user (or created by another user but entered by this user) in the first electronic calendar for an event, such as a training session, a meeting, a party, a birthday, a wedding, a class, a reunion, a concert, a deadline, etc. The event can last for minutes, hours within a day, hours on separate days, or can span a couple of days, and the present disclosure is not intended to be limiting.

In some implementations, the first and second entries in the structured calendar data associated with the first electronic calendar can each include a plurality of fields (e.g., a fixed number of fields). As a non-limiting example, the first entry can have a temporal field with a value of “Jul. 4, 2018”, an event field with a value of “Independence Day”, an attendee field left blank (indicating a value of N/A), a location field left blank, and/or a description field with a value such as “riverside fireworks at 9 pm”, etc. Similarly, the second entry can, for example, have a temporal field with a value of “Feb. 22, 2015, 9 pm-10 pm”, an event field with a value of “Jazz concert”, an attendee field with a value of “Helen & me”, a location field with a value of “Concert Hall”, and/or a description field with a value such as “parking at parking lot A across the Concert Hall, need to arrive 15 min earlier”. Optionally, the first and second entries, while being displayed remotely from each (e.g., on separately calendar months or years), can be stored structurally using a standard format (e.g., table) or a data model.

Optionally or additionally, the user of the client computing device 11 can use the calendar application 115 to access a second electronic calendar shared by an additional user for structured calendar data. Like that from the first electronic calendar, the structured calendar data from the second electronic calendar can include one or more entries created in the second electronic calendar for one or more events that respectively correspond to the one or more entries. For example, the second electronic calendar can include a third entry for an event (e.g., a group meeting) that the additional user has confirmed to attend, and/or a fourth entry created for a birthday of the additional user's best friend. In some cases, the user may be a co-worker of the additional user, or a family member of the additional user, so that the additional user grants the user temporary (or permanent, or partial) permission to access the second electronic calendar. In some other cases, the second electronic calendar can be a public calendar accessible within the public, or a private calendar shared within a group of people, where a member within the group is not required to request permission to access each time he or she wants to access the second electronic calendar after being added as a member to the group.

In some implementations, the client computing device 11 can further include one or more data storage 117, where the one or more data storage 117 can store structured calendar data 1171, unstructured data such as preference data 1173, and/or other data 1175 (e.g., electronic notes) described in this disclosure.

In some implementations, the client computing device 11 can include, or otherwise access, a content generation system 113 in communication with one or more machine learning (ML) models 14. The one or more ML models 14 can include, for example, a large language model (LLM) 142, where the LLM 142 can be a T5, GPT-3, or other language models. The content generation system 113 can include, for example, a query recognition engine 1131, where the query recognition engine 1131 can process natural language content parsed from a text message (or translated from a voice message) to determine whether the text message (or the voice message) includes a query that is relevant to any of the aforementioned electronic calendars (e.g., the first electronic calendar). Alternatively or additionally, the query recognition engine 1131 can process a voice message (or spoken utterance) directly to determine whether the voice message (or the spoken utterance) includes a query that is relevant to any of the aforementioned electronic calendars (e.g., the first or second electronic calendar).

As a non-limiting example, the user of the client computing device 11 can receive an email containing content (i.e., “Are you free next Thursday”), via the messaging application 111, and the query recognition engine 1131 can process the email to determine that such email includes a query relevant to the first electronic calendar based on the content (i.e., “Are you free next Thursday”) includes a temporal term (i.e., “Thursday”) and a noun (i.e., “you”) referring to the user of the client computing device 11, with which the first electronic calendar is associated. Optionally or additionally, the query recognition engine 1131 can determine the query as a candidate for use in subsequent priming of the LLM 142, based on identifying an entry in the first electronic calendar created for the user next Thursday.

As another non-limiting example, the user of the client computing device 11 can receive a spoken utterance (e.g., “Hey Assistant, do I have time to go to the dentist tomorrow?”) via an automated assistant (see FIG. 1B), where the spoken utterance is processed into natural language content (e.g., “do I have time to go to the dentist tomorrow” in natural language). The query recognition engine 1131 can process the natural language content (e.g., “do I have time to go to the dentist tomorrow”) to determine that the spoken utterance includes a query relevant to the first electronic calendar.

Optionally, the query recognition engine 1131 can determine that the spoken utterance (e.g., “Hey Assistant, do I have time to go to the dentist tomorrow?”) includes a query relevant to the second electronic calendar, based on the natural language content (e.g., “do I have time to go to the dentist tomorrow”) processed from the spoken utterance including: (1) one or more temporal terms (i.e., “tomorrow”); and (2) a noun (i.e., “I”) associated with the first electronic calendar (e.g., a private calendar of the user that provides the spoken utterance).

As a further non-limiting example, the user of the client computing device 11 can receive a spoken utterance (e.g., “Hey Assistant, when is Sarah's birthday?”) via an automated assistant (see FIG. 1B), where the spoken utterance is processed into natural language content (e.g., “when is Sarah's birthday” in natural language). The query recognition engine 1131 can process the natural language content (e.g., “when is Sarah's birthday”) to determine that the spoken utterance includes a query relevant to the second electronic calendar (e.g., a semi-private or a public calendar shared within a group of friends for birthdays, gatherings, and outdoor activities). In this example, the spoken utterance (e.g., “Hey Assistant, when is Sarah's birthday?”) can be determined to include a query relevant to the second electronic calendar, based on the natural language content (e.g., “when is Sarah's birthday”) processed from the spoken utterance including one or more temporal terms (i.e., “when” and “birthday”) and a noun (i.e., “Sarah”) appearing in one or more entries of the second electronic calendar. Optionally or additionally, the query recognition engine 1131 can determine the query as a candidate for use in subsequent priming of the LLM 142, based on identifying an entry in the second electronic calendar that corresponds to Sarah's birthday.

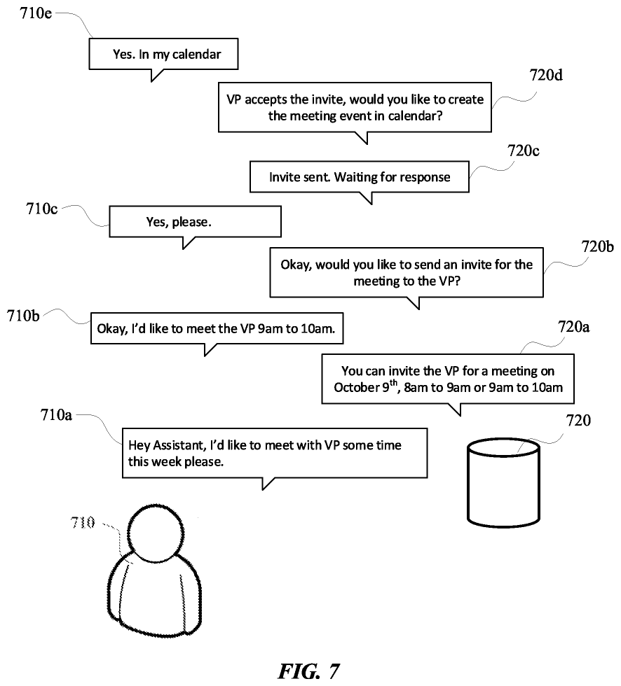

As an additional non-limiting example, referring to FIG. 7, a client computing device 720 (e.g., a smart speaker) of a user 710 can receive a spoken utterance 710a (e.g., “Hey Assistant, I'd like to meet with the VP sometime this week please”) from the user 710 via an automated assistant (see FIG. 1B, not shown in FIG. 7) installed at the client computing device 720, where the spoken utterance can be processed into natural language content (e.g., “I want to meet with the VP sometime this week” in natural language). The query recognition engine 1131 can process the natural language content (e.g., “I want to meet with the VP sometime this week”) to determine that the spoken utterance includes a query relevant to an electronic calendar of the VP. In some implementations, the query recognition engine 1131 can, for example, use a first ML model of the one or more ML models 14 to determine that the spoken utterance (e.g., “Hey Assistant, I'd like to meet with the VP sometime this week please”) includes a query (e.g., “does the VP have time this week for a meeting” in natural language), and further use a second ML model of the one or more ML models 14 to determine that the query is relevant to an electronic calendar of the VP. The second ML model can determine that the query is relevant to an electronic calendar of the VP based on one or more terms (e.g., “time this week” and “VP”) in the query (e.g., “does the VP have time this week for a meeting”).

In some implementations, the content generation system 113 can further include, for example, a LLM engine 1133 in communication with the LLM 142. The LLM engine 1133 can prime the LLM 142 using one or more priming input. The one or more priming input can include, for example, a first priming input generated based on one or more entries from the structured calendar data of the first electronic calendar (or of the second electronic calendar, or other electronic calendar). Continuing with the above example in which the query recognition engine 1131 processes the natural language content (e.g., “I want to meet with the VP sometime this week”) from the spoken utterance (e.g., “Hey Assistant, I'd like to meet with the VP sometime this week please”) to determine that such natural language content includes a query (e.g., “does the VP have time this week for a meeting”) relevant to an electronic calendar of the VP, the LLM engine 1133 can generate a first priming input using entries of the electronic calendar of the VP for the rest of the week.

For example, a portion of the electronic calendar of the VP having entries for the rest of the week can include a first entry (e.g., “recruiting interview, October 9th, 3 pm-4 pm”), a second entry (e.g., “out of office, from October 10 th (all day), to October 11th, 1 pm”), and a third entry (e.g., “group meeting, October 11th, 1:30 pm to 3 pm). The LLM engine 1133 can process the first, second, and third entries of the electronic calendar of the VP to generate a first priming input, where the first priming input can be, for example, in natural language content that includes a description of “VP is available October 9th before 3 pm or after 4 pm, and available on October 11th between 1 pm and 1:30 pm or after 3 pm”. The LLM engine 1133 can the prime the LLM model 142 using the first priming input (e.g., “VP is available October 9th before 3 pm or after 4 pm, and available on October 11th between 1 pm and 1:30 pm or after 3 pm” in natural language, or “VP is available the rest of week on October 9th before 3 pm or after 4 pm, or on October 11 th between 1 pm and 1:30 pm or after 3 pm” in natural language). After being primed using the first priming input, the LLM engine 1133 can process the query (e.g., “does the VP have time this week for a meeting”) using the primed LLM model 142 to generate a LLM output. The LLM output, in this case, can be “on October 9th, the VP has time for a meeting before 3 pm or after 4 pm, and on October 11th, the VP has time for a meeting between 1 pm and 1:30 pm, or after 3 pm”.

Optionally or additionally, in the above example, the LLM engine 1133 can process a portion of an electronic calendar of the user 710 for the rest of the week, in addition to the portion of the electronic calendar of the VP for the rest of the week, to generate a first priming input. The portion of an electronic calendar of the user 710 for the rest of the week can, for example, include an entry for October 9th (e.g., out of office, October 9th, all day) and an additional entry for October 11th (e.g., meeting with manager A, October 11th, 3-5 pm). Correspondingly, the LLM engine 1133 can generate a first priming input such as, “both you and VP are available on October 11th, between 1 pm and 1:30 pm this week”. Optionally or additionally, the LLM engine 1133 can process user characterization data (e.g., user data indicating a position, title, or a category label of the user 710, i.e., director of engineering, and/or relationship data indicating a relationship between the user 710 and the VP, e.g., user 710 directly reports to the VP as the director of engineering), in addition to the portion of the electronic calendar of the user 710 for the rest of the week and the portion of the electronic calendar of the user 710 for the rest of the week. In this case, the LLM engine 1133 may generate a first priming input such as, “director of engineering and VP are both available on October 11 th, between 1 pm and 1:30 pm this week”.

As another non-limiting example, the first priming input can include a natural language representation (e.g., Helen and I will go to Concert Hall attending the Jazz concert on Feb. 22, 2015 from 9 pm to 10 pm, need to arrive 15 min earlier to park at parking lot A across the Concert Hall) generated based on a calendar entry (e.g., “Helen & me|Jazz concert|Concert Hall|Feb. 22, 2015, 9 pm to 10 pm|parking at parking lot A across the Concert Hall, need to arrive 15 min earlier”) of the first electronic calendar.

Optionally or additionally, the first priming input can include the calendar entry, in addition to the first natural language representation. Referring to the aforementioned non-limiting example, the first priming input can include: (1) the calendar entry (e.g., “Helen & me|Jazz concert|Concert Hall|Feb. 22, 2015, 9 pm to 10 pm|parking at parking lot A across the Concert Hall, need to arrive 15 min earlier”), and/or (2) the first natural language representation (e.g., Helen and I will go to Concert Hall attending the Jazz concert on Feb. 22, 2015 from 9 pm to 10 pm, need to arrive 15 min earlier to park at parking lot A across the Concert Hall).

Optionally or additionally, the first priming input can include unstructured message data (e.g., a message containing “Hey, could I join you and Helen for the Jazz concert?—Lily”), in addition to the first natural language representation. In this situation, the first priming input can include: (1) natural language content (e.g., “Lily wants to join Helen & I for the Jazz concert”), generated based on the message (e.g., “Hey, could I join you and Helen for the Jazz concert?—Lily”); and/or (2) the first natural language representation (e.g., Helen and I will go to Concert Hall attending the Jazz concert on Feb. 22, 2015 from 9 pm to 10 pm, need to arrive 15 min earlier to park at parking lot A across the Concert Hall).

As another non-limiting example, the one or more priming input can include a second priming input, where the second priming input can include a second natural language representation (e.g., On Sep. 12, 2013 next Thursday, one-on-one meeting with Bill at Meeting Room between 10 am and 10:30 am and take Frank to First Animal Hospital for vet visit—rabies vaccine between 4:30 pm and 5 pm), which is generated based on a first and a second calendar entries (e.g., “Bill and I|one-on-one meeting|Meeting Room|Sep. 12, 2013, 10 am to 10:30 am|N/A” and “me|vet visit|First Animal Hospital|Sep. 12, 2013, 4:30 pm to 5 pm|rabies vaccine for Frank”) of the first electronic calendar.

After being primed using (for example) the second priming input, the LLM 142 can be used to process a query input (e.g., David sent you an email today, Sep. 6, 2013, at 3:23 pm, asking whether you are free next Thursday) that is generated based on a query (e.g., an email containing “Are you free next Thursday”, received from David via the messaging application 111 on Sep. 6, 2013, at 3:23 pm), to generate an LLM output. In this case, the LLM output can be, for example, “not available 10 am˜10:30 am and 4:30 pm˜5 pm next Thursday”.

In some implementations, the content generation system 113 can further include a response-generation engine 1135. The response-generation engine 1135 can, for example, process or modify the aforementioned LLM output (e.g., “not available 10 am˜10:30 am and 4:30 pm˜5 pm next Thursday”) to generate a response (e.g., “I am free next Thursday except for 10 am˜10:30 am and 4:30 pm˜5 pm”, or “on Thursday, I am free between 10:30 am and 4:30 pm”) to the aforementioned query. The response can be rendered in natural language (or audibly), that answers the query in the email containing “Are you free next Thursday”, where the email is received from the requesting user (e.g., a user named David) via the messaging application 111. The response can be rendered to the user of the client computing device 11 as a selectable element, where the user can select the selectable element to enter the response (e.g., “I am free next Thursday except for 10 am˜10:30 am and 4:30 pm˜5 pm”) as a reply to David's email that contains “Are you free next Thursday”.

Turning to the aforementioned example in which the LLM engine 1133 has primed the LLM model 142 with the first priming input (e.g., “VP is available October 9th before 3 pm or after 4 pm, and available on October 11th between 1 pm and 1:30 pm. or after 3 pm” in natural language) to generate a LLM output (e.g., “on October 9th, the VP has time for a meeting before 3 pm or after 4 pm, and on October 11th, the VP has time for a meeting 1 pm˜1:30 pm, or after 3 pm”), the response-generation engine 1135 can be configured to process the LLM output to generate a response to the query (e.g., “does the VP have time this week for a meeting”). For example, the response-generation engine 1135 can directly output the LLM output as the response.

Alternatively or additionally, the response-generation engine 1135 can search for and/or identify unstructured data (that is associated with the LLM output), such as an email message from the VP to all saying that “starting from October 1, the company will offer free lunch between 12 pm to 1 pm every workday for full-time employees”. The response-generation engine 1135 can process the LLM output and the identified unstructured data to generate the response, which modifies the LLM output to read as, “on October 9th, the VP has time for a meeting before 12 pm, 1 pm-3 pm, or after 4 pm, and on October 11th, the VP has time for a meeting between 1 pm and 1:30 pm, or after 3 pm”.

Alternatively or additionally, the response-generation engine 1135 can retrieve unstructured calendar data (e.g., user preference data, also called as “preference data”), and process the LLM output and the unstructured calendar data (e.g., user preference data) to generate the response. The response-generation engine 1135 can, for example, retrieve user preference data of the user of the spoken utterance from which the query is identified and/or user preference data of the vice president (VP). As a non-limiting example, the response-generation engine 1135 can retrieve the user preference data of the VP and can determine that the user preference data of the VP indicates that the VP has a preference for a meeting between Sam to 10 am. In this example, the response-generation engine 1135 can process the LLM output (e.g., “on October 9th, the VP has time for a meeting before 3 pm or after 4 pm, and on October 11th, the VP has time for a meeting October 11th between 1 pm and 1:30 pm or after 3 pm”) and the user preference data of the VP indicates that the VP has a preference for a meeting between Sam to 10 am, to generate the response (e.g., response 720a in FIG. 7) which reads, “invite the VP for a meeting on October 9th, Sam to 9 am or 9 am to 10 am”.

The response 720a can be rendered to the user 710 audibly, and the user 710 can further interact with the client computing device 720 by providing an additional spoken utterance 710b (e.g., I'd like to meet the VP 9 am to 10 am) received by the automated assistant installed at (or otherwise accessible by) the client computing device 720. In response to receiving the additional spoken utterance 710b, the automated assistant can render, via a microphone of the client computing device 720b, an additional response 720b (e.g., “Okay, would you like to send an invite for the meeting over to the VP?”). And in response to a further spoken utterance 710c (e.g., “yes, please”) from the user 710, the automated assistant can generate and send an invite (via an audio message describing the invite, or via a text message/email containing a link to the invite) to the VP, and then outputs a further response 720c (e.g., “Invite sent. Waiting for response.”).

Optionally or additionally, the automated assistant can output a follow-up response in response to the VP accepting the invite (for example, by selecting the link), where the follow-up response is an alerting sound that alerts the user 710 there is a notification to read (or hear), or the follow-up response can be an audio message 720d (e.g., “VP accepts the invite, would you like to create the meeting event in calendar?”) rendered automatically in response to the VP accepting the invite. If the user 710 confirms with an input 710e (e.g., “Yes, in my calendar”), the automated assistant can create an entry for “meeting with VP on October 9th, 9 am to 10 am” in a working calendar of the user 710. If the user 710 confirms with a different input (e.g., “yes, in my calendar and the VP's calendar”), the automated assistant can create an entry for “meeting with VP on October 9th, 9 am to 10 am” in a working calendar of the user 710 and create an entry for “meeting with VP on October 9th, 9 am to 10 am” in a working calendar of the VP (if permitted, and if not permitted, may seek permission to create such entry from the VP first). The conversation between the user 710 and the automated assistant via the client computing device 720 can continue with additional communications with respect to user permission, user confirmation, modification of the entry in the calendar, etc., and the present disclosure is not intended to be limiting. Optionally or alternatively, the automated assistant can create an entry for “meeting with employee David on October 9th, 9 am to 10 am” in a working calendar of the VP in response to the VP accepting the invite.

Additionally or alternatively, instead of the response 720a that is rendered audibly to the user 710, one or more selectable elements corresponding to the generated response (e.g., having content the same as or similar to the response 720a in natural language) can be rendered to the user 710 via a display of the client computing device 720. For example, the one or more selectable elements can be a single selectable element that corresponds to “meeting with the VP on October 9th, 9 am to 10 am”. Alternatively, the one or more selectable elements can include a first selectable element that corresponds to “8 am to 9 am” and a second selectable element that corresponds to “9 am to 10 am”. When one of the one or more selectable elements is selected, an invite for a meeting on October 9th, 8 am to 9 am (and/or 9 am to 10 am, depending on design of the one or more selectable elements and the user selection of the one or more selectable elements) can be sent to the VP, along with a description including for example “Sam asks: I'd like to meet with the VP sometime this week please”. Optionally, the VP can accept the invite for the meeting by selecting “October 9th, 8 am to 9 am” as the proposed time for the meeting, and optionally, in response to the VP accepting the invite, a calendar entry for “Meeting (Sam and VP), October 9th, 8 am to 9 am” can be created in the electronic calendar of the VP and in an electronic calendar of Sam (the user that provides the spoken utterance, i.e., “I'd like to meet with the VP sometime this week please”).

In some implementations, the content generation system 113 can further include a calendar-processing engine 1137 that processes structured calendar data (e.g., entries in an electronic calendar) of an electronic calendar to generate a natural language presentation of the structured calendar data. As a non-limiting example, the calendar-processing engine 1137 can process an entry (e.g., “Helen & me|Jazz concert|Concert Hall|Feb. 22, 2015, 9 pm to 10 pm|parking at parking lot A across the Concert Hall, need to arrive 15 min earlier”) of the first electronic calendar, to generate a corresponding natural language presentation (e.g., Helen and I will go to Concert Hall attending the Jazz concert on Feb. 22, 2015 from 9 pm to 10 pm, need to arrive 15 min earlier to park at parking lot A across the Concert Hall).

In some implementations, the server 12 can include a query recognition engine 121, a LLM engine 123, a response-generation engine 125, and/or a calendar-processing engine 127. The query cognition engine 121 can be the same as (or similar to) the query recognition engine 1131 accessible locally at the client computing device 11. For example, the query cognition engine 121 can determine whether a message or a spoken utterance includes a query relevant to an electronic calendar. Being accessible via the server 12, the query recognition engine 121 may perform such determination in a more efficient way than the query recognition engine 1131. Accordingly, to prevent such determination occupying too much (or unnecessary) computing resources of the client computing device 11, the client computing device 11 may offload such determination process to the query cognition engine 121.

Similarly, the LLM engine 123 can be the same as or similar to the LLM engine 1133, the response-generation engine 125 can be the same as or similar to the response-generation engine 1135, and the calendar-processing engine 127 can be the same as or similar to the calendar-processing engine 1137. To put it in another way, the LLM engine 123 can be a cloud counterpart (e.g., offering service in a cloud computing environment) of the LLM engine 1133 at the client computing device 11, the response-generation engine 125 can be a cloud counterpart of the response-generation engine 1135, and the calendar-processing engine 127 can be a cloud counterpart of the calendar-processing engine 1137. In this case, the environment 100A can be the cloud computing environment in which a plurality of computing devices, which can be in the order of hundreds or thousands or more, share resources over the one or more networks 15. Repeated descriptions can be found in descriptions of this specification, and thus are omitted here.

FIG. 1B depicts a block diagram of another example environment 100B that demonstrates various aspects of the present disclosure, and in which implementations disclosed herein may be implemented. As shown in FIG. 1B, the environment 100B can include the client computing device 11 having a local automated assistant 119. The environment 100B can further include a cloud-based automated assistant 13 that is in communication with the client computing device 11 via one or more networks 15. Optionally, the client computing device can include a messaging application 111, a calendar application 115, and a data storage 117. The local automated assistant 119 can access one or more ML models 14, and can include the aforementioned LLM engine 1131 in communication with the LLM 142 of the one or more ML models 14. The local automated assistant 119 can receive a user input 17 via an input device of the client computing device 11. For example, the user input 17 can be a spoken utterance, and be received by the local automated assistant 119 via a microphone of the client computing device 11. The user input 17 can also be a touch input, a camera input, or a keyboard input, received by the local automated assistant 119 via a touch screen, a camera, or a keyboard of the client computing device 11, and the present disclosure is not limited thereto.

The cloud-based automated assistant 13 can include an automatic speech recognition (ASR) engine 131, a natural language understanding (NLU) engine 133, a text-to-speech (US) engine 135, and a content generation system 137. The ASR engine 131 can process audio data that captures a spoken utterance to generate a recognition of the spoken utterance. The NLU engine 133 can determine semantic meaning(s) of audio and/or text converted by the ASR engine from audio, and decompose the determined semantic meaning(s) to determine intent(s) and/or parameter(s) for an assistant action. For example, the NLU engine 133 can determine an intent and/or parameters for an assistant action based on the aforementioned recognition of the spoken utterance generated by the ASR engine 131.

In some implementations, the NLU engine 133 can resolve the intent(s) and/or parameter(s) based on a single utterance of a user and, in other situations, prompts can be generated based on unresolved intent(s) and/or parameter(s), those prompts rendered to the user, and user response(s) to those prompt(s) utilized by the NLU engine 133 in resolving intent(s) and/or parameter(s). In those situations, the NLU engine 133 can optionally work in concert with a dialog manager engine (not illustrated) that determines unresolved intent(s) and/or parameter(s) and/or generates corresponding prompt(s). The NLU engine 133 can utilize one or more NLU machine learning models, out of the one or more ML models 14, in determining intent(s) and/or parameter(s).

The US engine 135 can convert text to synthesized speech, and can rely on one or more speech synthesis neural network models in doing so. The US engine 135 can be utilized, for example, to convert a textual response into audio data that includes a synthesized version of the text, and the synthesized version can be audibly rendered via hardware speaker(s) of the client computing device 11 or another device. The content-generation system 137 can be the same as or similar to the aforementioned content-generation system 113, and repeated descriptions are not provided herein.

In some implementations, an automated assistant (i.e., local automated assistant 119) can, for example, use the NLU 133 (accessible locally or remotely) to determine that a text message (e.g., “Liam, do you have time tomorrow? just curious”) received via an instant messaging application includes a query (e.g., “Do you have time tomorrow” or “Liam, do you have time tomorrow”), where the text message can be dated Feb. 5, 2017, at 2:45 pm. The automated assistant (i.e., the local automated assistant 119) can process the query locally (if the automated assistant includes or otherwise can access the content generation system 113), or forward the query to the cloud-based automated assistant 13 for remote processing. The query can be processed locally or remotely to determine that the query is relevant to an electronic calendar, for example, based on the automated assistant identifying an entry (e.g., “vacation to Puerto Rico from February 3rd to February 16th”) in the electronic calendar to be responsive to the query. In this case, the automated assistant can prime the LLM model 142 using the entry (e.g., “vacation to Puerto Rico from February 3rd to February 16th”) of the electronic calendar, and then process the query (e.g., “Do you have time tomorrow”) using the LLM model 142 that is primed with the entry (e.g., “vacation to Puerto Rico from February 3rd to February 16th”), where the primed LLM model 142 processes the query (e.g., “Do you have time tomorrow”) to generate a LLM output such as, “I don't have time tomorrow”.

Optionally, the automated assistant can further determine, using the content generation system 113 and based on the LLM output, a response to the query. For example, the automated assistant can determine, based on the LLM output (e.g., “I don't have time tomorrow”) and based on the entry (e.g., “vacation to Puerto Rico from February 3rd to February 16th”), that the response includes a natural language response, e.g., “I don't have time tomorrow. I am away from February 3rd to February 16th” or “I don't have time tomorrow, my whole calendar tomorrow is full.” The automated assistant can cause the natural language response (e.g., “I don't have time tomorrow, my whole calendar tomorrow is full.”) to be rendered as a selectable element via an interface of the instant messaging application. When selected, the natural language response (e.g., “I don't have time tomorrow, my whole calendar tomorrow is full.”) can be entered into a text-input field at the interface of the instant messaging application as a reply (or part of the reply) to the aforementioned text message (e.g., “Liam, do you have time tomorrow? just curious”). The natural language response can be sent out directly, or can be edited before being sent out. This way, a user does not need to check his or her calendar(s) to formulate a response to a query relevant to his or her calendar(s).

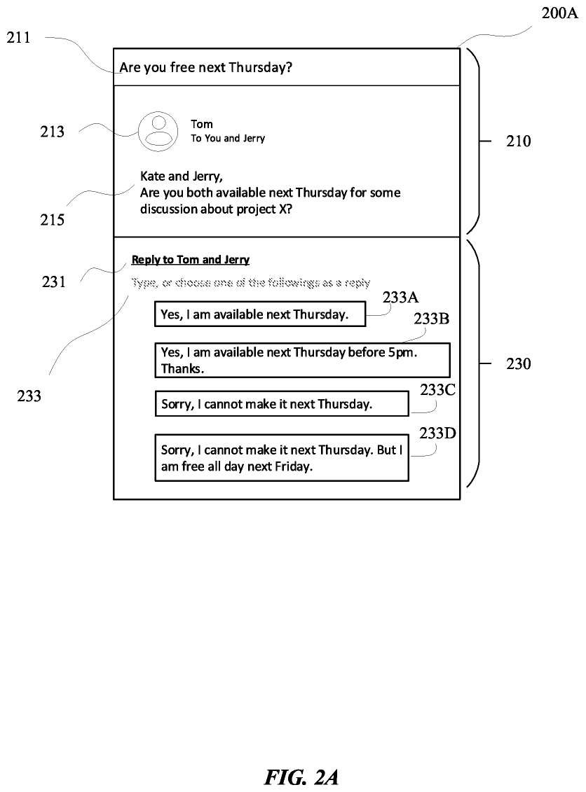

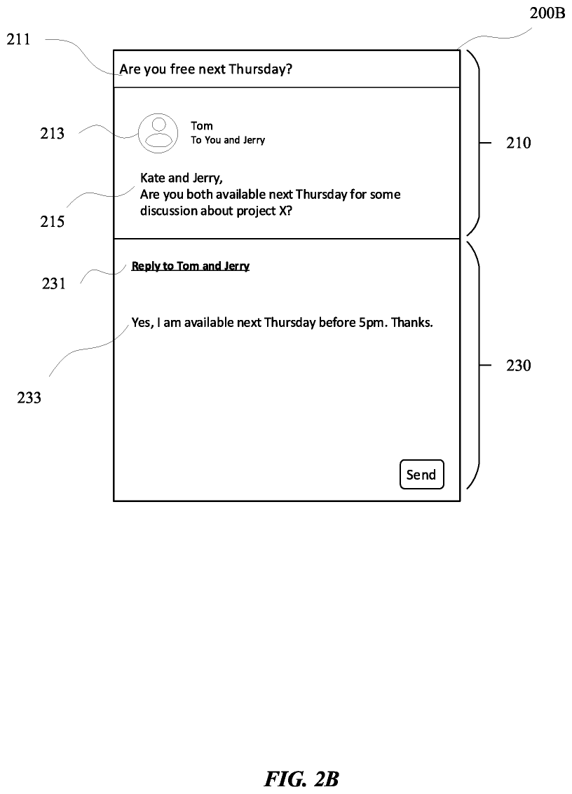

FIG. 2A depicts an example user interface 200A for providing one or more selectable elements for selection as a response to a query from an email, in accordance with various implementations. FIG. 2B depicts another example user interface 200B transitioned from the user interface 200A and showing user selection of the response, in accordance with various implementations.

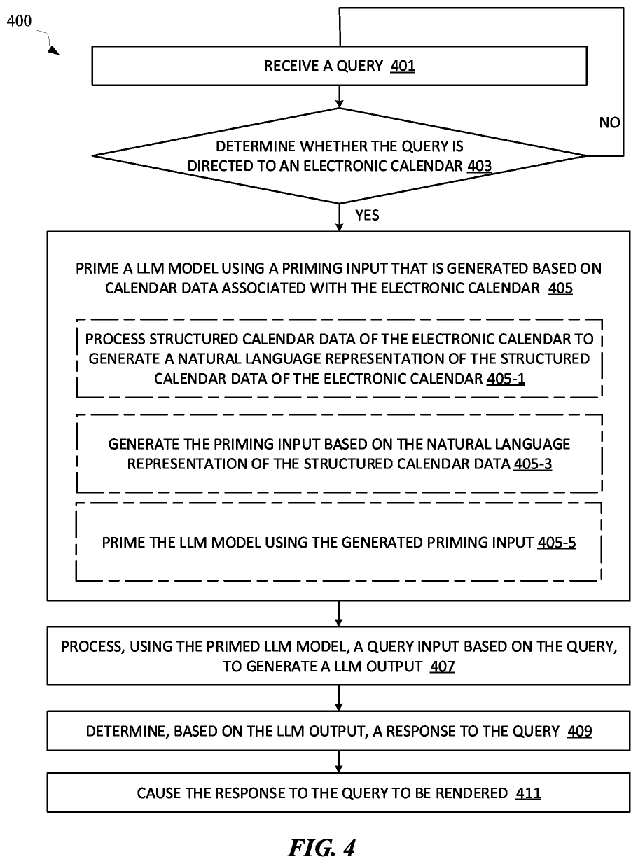

FIG. 4 illustrates an example method 400 for generating an automatic reply in response to a message, in accordance with various implementations. For convenience, the operations of the method 400 are described with reference to a system that performs the operations. The system of method 400 includes one or more processors and/or other component(s) of a client device and/or of a server device. Moreover, while operations of the method 400 are shown in a particular order, this is not meant to be limiting. One or more operations may be reordered, omitted, or added.

At block 401, the system receives a query. As a non-limiting example, the query can be a query (e.g., “When VP is available this week?”) recognized from audio data, e.g., a spoken utterance such as “Hey Assistant, I'd like to meet with the VP sometime this week please” (see FIG. 7). As another non-limiting example, the query can be a query (e.g., “Is Kate free next Thursday?” or “What is Kate's schedule next Thursday”) recognized from a message (e.g., an email received by Kate asking “are you free next Thursday for project discussion”, see FIG. 2A). As a further non-limiting example, the query can be a textual query detected from textual input via a touch screen, keyboard, or other input unit.

Optionally, prior to receiving a query, the system can receive a message or audio data capturing a spoken utterance, and determine whether the message or the spoken utterance includes a query. As a non-limiting example, referring to FIG. 2A, when an email message 210 (e.g., Title 211: “Are you free next Thursday”; Sender/recipient(s) 213: Tom/Kate and Jerry; Email body 215: “Kate and Jerry, Are you both available next Thursday for some discussion about project X?”) is received, the email message 210 can be processed. In this example, based on detecting a question mark and/or one or more terms representing a query (e.g., “are you”) from the email message 210 (e.g., the email body 215 and/or the email title 211), the email message 210 can be determined to include a query. Here, the query can be determined as “Kate and Jerry, Are you both available next Thursday for some discussion about project X?” or “Are Kate and Jerry available next Thursday for project discussion”, and the present disclosure is not limited thereto.

At block 403, the system determines whether the query is directed to an electronic calendar. As a non-limiting example, the system can determine whether the query is directed to an electronic calendar based on whether the query includes a first keyword representing a human entity (e.g., “my daughter”) and/or whether the query includes a second keyword that is temporal-based (e.g., “Friday”). The first keyword representing a human entity can include, for example, a human name (e.g., “Mary”), a title in an organization/family (e.g., “professor for the economy class”, or “niece”), a noun (e.g., “she”), and/or other human entity keyword(s). The second keyword that is temporal-based can be, for example, a temporal-related term (e.g., “this weekend”), or one or more temporal-related words (e.g., “when” and/or “birthday”), and/or other temporal-related term(s). For instance, when a query is recognized from a message as “Is Kate free next Thursday for discussion of project X”, the query can be determined to be directed to an electronic calendar of Kate based on including keywords of “Kate” (a human entity) and “next Thursday” (temporal term). Optionally, determining whether the query includes the first keyword and determining whether the query includes the second keyword can be performed simultaneously. Optionally, determining whether the query includes the first keyword can be performed prior to determining whether the query includes the second keyword. Optionally, determining whether the query includes the second keyword can be performed prior to determining whether the query includes the first keyword.

In some implementations, at block 403, the system can determine a query is relevant to more than one calendar. Referring to FIG. 2A, as a non-limiting example, a client device may receive an email message having a title 211 (i.e., “Are you free next Thursday?”), a message body 215 (i.e., “Kate and Jerry, Are you both available next Thursday for some discussion about project X?”), and sender/recipient information 213 (i.e., the message is sent by Tom to Kate and Jerry). In this example, a query can be recognized from the email message as: “what are Kate's and Jerry's schedules next Thursday”. Such query can be determined to be relevant to two calendars (i.e., Kate's calendar and Jerry's calendar), based on having human entity keywords (i.e., “Kate” and “Jerry”) and the temporal term (i.e., “next Thursday”). In this case, metadata may be applied, in addition to the human entity keywords and the temporal term to determine a calendar that the query is directed to. For instance, based on metadata (e.g., a reply message 230 is being compiled by Kate to Tom and Jerry), the query can be determined to be directed to Kate's calendar.

At block 405, the system primes an LLM model using a priming input that is generated based on calendar data associated with the electronic calendar. In some implementations, in priming the LLM model (405), the system can perform one or more of sub-blocks 405-1, 405-3, and/or sub-block 405-5. At sub-block 405-1, the system processes structured calendar data of the electronic calendar to generate a natural language representation of the structured calendar data of the electronic calendar. The electronic calendar, for example, can be a private calendar of a first user, accessible by the first user via a calendar application (or an application having a calendar module). In this example, the first user can create one or more private calendar entries in the private calendar, or the first user may receive a calendar invite and accept the calendar invite to create one or more shared calendar entries (shared only between the first user and the inviter who sends the calendar invite) in the private calendar. As another example, the electronic calendar can be a public calendar shared within a group of users (e.g., a group of coworkers, or a group of friends), where each user within the group can create one or more public calendar entries shared within the group, in the public calendar.

In some implementations, the structured calendar data can include one or more entries of the electronic calendar, and in processing the structured calendar data of the electronic calendar to generate a natural language representation of the structure calendar data of the electronic calendar (sub-block 405-1), the system can: process the one or more entries of the electronic calendar data to generate a natural language representation of the one or more entries. As a non-limiting example, the electronic calendar of the first user (e.g., user A) can include a calendar entry (Title: Sue's birthday; Time: Jul. 8, 2012, all day; Visibility: shared), and this calendar entry can be processed to generate a natural language representation of the calendar entry, i.e., “Sue's birthday is July 8th” or “Sue's birthday is July 8th, next Thursday”.

Optionally, in processing the one or more entries of the electronic calendar data to generate a natural language representation of the one or more entries, the system can: process each of the one or more entries separately to generate a respective natural language representation of a corresponding entry, of the one or more entries. As a non-limiting example, the electronic calendar of the first user (e.g., user A) can include a first entry (Title: Sue's birthday; Time: Jul. 12, 2012, all day; Visibility: shared) and a second entry (Title: pick up Bob at the airport; Time: Jul. 15, 2012, 3:00 pm to 6:00 pm EST; Visibility: private). In this example, processing the one or more entries of the electronic calendar can include: processing the first entry to generate a first natural language representation (e.g., Sue's birthday is July 12th) of the first entry, and processing the second entry to generate a second natural language representation (e.g., user A will pick up Bob at the airport between 3 to 6 pm on Jul. 15, 2012).

Optionally, in processing the one or more entries of the electronic calendar to generate a natural language representation of the one or more entries, the system can: process a plurality of entries within a same period of time to generate a single, corresponding natural language representation of the plurality of entries. As a non-limiting example, the electronic calendar of the first user (e.g., user B) can include a first entry (Title: Meeting; Time: Jul. 6, 2012, 2:00 pm to 3:00 pm EST; Location: Conference room; Visibility: private; Description: N/A) and a second entry (Title: dental appointment; Time: Jul. 6, 2012, 8:00 am to 10:00 am EST; Location: 365 Old Town Street; Visibility: private; Description: dental cleaning) having the same format. In this example, the first and second entries can be processed to generate a natural language representation, e.g., “User A is not available Jul. 6, 2012, 8:00 am to 10:00 am EST and 2:00 pm to 3:00 pm EST” (or, “On Jul. 6, 2012, User B is away for dental appointment 8:00 am to 10:00 am EST and away for a meeting 2:00 pm to 3:00 pm EST”, etc.).

At sub-block 405-3, the system can generate the priming input based on the generated natural language representation of the structured calendar data. As a non-limiting example, the priming input can include the natural language presentation (e.g., “Sue's birthday is July 8th, next Thursday”) generated at sub-block 405-1 using one or more entries of the electronic calendar. As another non-limiting example, the priming input can include: (1) the natural language representation (e.g., “Sue's birthday is July 8th, next Thursday”) of the structured calendar data of the electronic calendar, generated at sub-block 405-1; and (2) the structured calendar data (e.g., calendar entry: “Title: Sue's birthday; Time: Jul. 8, 2012, all day; Visibility: shared”) of the electronic calendar. As an additional non-limiting example, the priming input can include: (1) the natural language representation (e.g., “Sue's birthday is July 8th, next Thursday”) of the structured calendar data of the electronic calendar; and (2) nonstructured calendar data (e.g., an earlier electronic reminder saying “I need to get up early next Thursday”) from a source other than the electronic calendar. As a further non-limiting example, the priming input can include: (1) the natural language representation (e.g., “Sue's birthday is July 8th, next Thursday”) of the structured calendar data of the electronic calendar; (2) the structured calendar data (e.g., calendar entry: “Title: Sue's birthday; Time: Jul. 8, 2012, all day; Visibility: shared”) of the electronic calendar; and/or (3) the nonstructured calendar data (e.g., an earlier text message saying “buy a birthday cake and go to Sue's home at 5 pm next Thursday”) from a source other than the electronic calendar. Optionally, the LLM model can be primed using a plurality of priming input.

At sub-block 405-5, the system primes the LLM model using the priming input generated at sub-block 405-3. Here, priming a LLM model (also referred to as “LLM”) using a priming input can be performed via a plurality of techniques. As a non-limiting example, after the system generates a priming input by processing structured calendar data of the electronic calendar to generate a natural language representation of the structured calendar data of the electronic calendar, the natural language representation and/or the structured calendar data can be used as the priming input to prime the LLM. As another non-limiting example, after the system retrieves unstructured data that includes preference data which indicates one or more preferred time slots of the requesting user and/or the receiving user, the preference data can be included as a part of the priming input (e.g., included in the priming input along with the natural language representation and/or the structured calendar data) to prime the LLM model. As a further non-limiting example, after a system retrieves metadata (also referred to as “auxiliary data”) including, for example, relationship data indicating a relationship between a user (i.e., “requesting user”) who sends a query and a user (i.e., “receiving user”) who receives the query (block 4055), the relationship data can be included in the priming input, with one or more other types of data (natural language representation of the structured calendar data, the structured calendar data, the unstructured data, etc.) described herein.

At block 407, the system processes, using the primed LLM model, a query input generated based at least on the aforementioned query, to generate a LLM output. For example, for the query (“Kate and Jerry, Are you both available next Thursday for some discussion about project X?”), a query input such as “Kate, are you available next Thursday to discuss project X?” can be generated based on (1) the query and (2) a fact that the client computing device that receives the message (e.g., email message 210) has no access to Jerry's electronic calendar. As another example, the query input can also be “search Kate's and Jerry's electronic calendars for events planned next Thursday, Jul. 8, 2012”. The query input can also be in other formats, and the present disclosure is not limited thereto. In these examples, the LLM output can be, for example, “Kate's electronic calendar shows next Thursday is Sue's birthday”, “Kate's electronic calendar shows next Thursday all day is Sue's birthday”, or “Kate's electronic calendar shows next Thursday is Sue's birthday, and Kate mentions in a text message to buy a birthday cake and go to Sue's home at 5 pm next Thursday”.

Optionally, at block 407, the system generates a plurality of query inputs and processes each, separately using the primed LLM model, to generate a plurality of LLM outputs. The plurality of LLM outputs can include a first LLM output (e.g., Kate's electronic calendar shows next Thursday is Sue's birthday), and a second LLM output (Kate's electronic calendar show next Thursday is Sue's birthday, and Kate mentions in a text message to “buy a birthday cake and go to Sue's home at 5 pm next Thursday”).

At block 409, the system determines, based on the LLM output, a response to the query. For example, based on the aforementioned first LLM output (e.g., “Kate's electronic calendar shows next Thursday is Sue's birthday”), a response 233 including first response content 233A, e.g., “Yes, I am available next Thursday”, can be generated. The first response content 233A can be generated based on the first LLM output and further based on metadata (e.g., user data) indicating that someone typically does not ask for leave at work for a friend's birthday.

Alternatively or additionally, the response 233 can include second response content 233B (e.g., Yes, I am available next Thursday before 5 pm). In some implementations, the second response content 233B can be generated based on the first LLM output (e.g., “Kate's electronic calendar shows next Thursday is Sue's birthday”) and based on unstructured data such as, the text message (e.g., “buy a birthday cake and go to Sue's home at 5 pm next Thursday”). In some embodiments, the second response content 233B can be generated based on the first response content 233A, e.g., “Yes, I am available next Thursday”, modified using the text message (e.g., “buy a birthday cake and go to Sue's home at 5 pm next Thursday”). In some embodiments, the second response content 233B can be generated based on the second LLM output (Kate's electronic calendar show next Thursday is Sue's birthday, and Kate mentions in a text message to “buy a birthday cake and go to Sue's home at 5 pm next Thursday”).

Alternatively or additionally, the response 233 can include third response content 233C (e.g., Sorry, I cannot make it next Thursday), generated based on the first LLM output (e.g., “Kate's electronic calendar shows next Thursday all day is Sue's birthday”). Alternatively or additionally, the response 233 can include fourth response content 233D (e.g., Sorry, I cannot make it next Thursday, but I am free all day Friday), generated based on the first LLM output (e.g., “Kate's electronic calendar shows next Thursday all day is Sue's birthday”) and metadata indicating that the structured calendar data of the electronic calendar for the user (i.e., Kate) includes no calendar entry for next Friday.

In other words, the response 233 can include one or more response content (e.g., 233A, 233B, 233C, and/or 233D in FIG. 2A), where the one or more response content can each be a selectable element, displayed at the user interface 200A of the client computing device, for user selection. Optionally, as shown in FIG. 2A, the user interface 200A can further include a reply message 230, including: a recipient address field 231 showing name(s) of the recipient(s), such as Tom and Jerry. Optionally, the response 233 can include instructions, such as “Type, or choose one of the following as a reply”, which disappears once user input is received to formulate the reply message 230 the email message 210.

At block 411, the system causes the response to be rendered. For example, referring to FIG. 2A, the response 233 can be rendered at the user interface 200A of the client computing device, where the response 233 includes first response content 233A displayed using a first selectable element, second response content 233B displayed using a second selectable element, third response content 233C displayed using a third selectable element, and/or fourth response content 233D displayed using a fourth selectable element. Referring to FIG. 2B, the user (e.g., Kate) of the client computing device can select, for example, the second selectable element to enter the second response content 233B (e.g., “Yes, I am available next Thursday before 5 pm”) in a text body of the reply message 230. The user can then select the icon “Send” at the user interface 200B to send out the reply message 230 to recipient(s) such as Tom and Jerry.

Optionally, in some implementations, given an electronic calendar of a user, the electronic calendar can be processed (e.g., at regular or non-regular intervals) to generate a natural language representation of the electronic calendar, prior to receiving any query directed to the electronic calendar. For example, an electronic calendar of Kate can be processed every day at 10 pm to generate a natural language representation of the electronic calendar. In this example, each day, entries of the electronic calendar of Kate entered prior to 10 pm can be processed to generate a natural language representation of the electronic calendar. If the next day (e.g., June 23), Kate speaks to an automated assistant, asking, “Assistant, do I have any meeting tomorrow”, the electronic calendar can be scanned or processed to detect whether there is any new entry created since 10 pm (June 22). If no new entry is created in the electronic calendar of Kate, the natural language representation of the electronic calendar generated on June 22 can be used to prime the LLM model, in preparation for generating a response to the query. If one or more entries are created in the electronic calendar of Kate, the one or more entries can be processed to modify the natural language representation of the electronic calendar generated on June 22, so that a modified language representation of the electronic calendar is obtained and used to prime the LLM model.

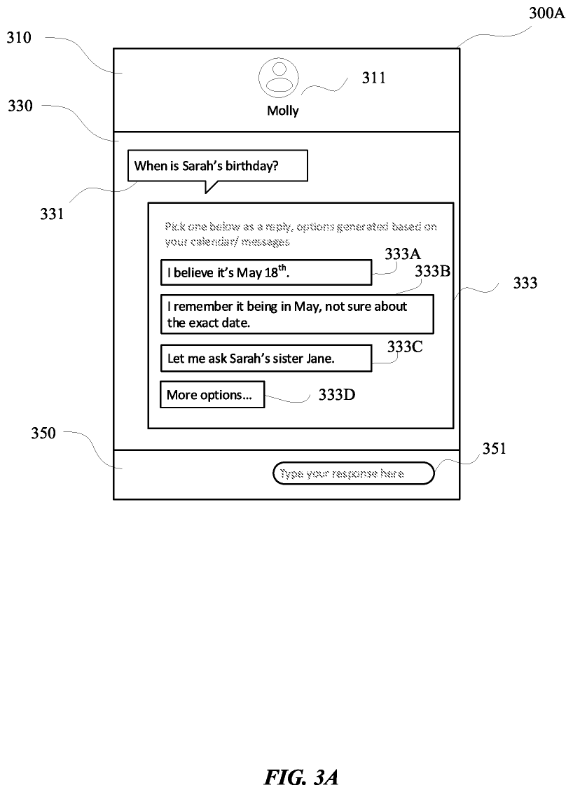

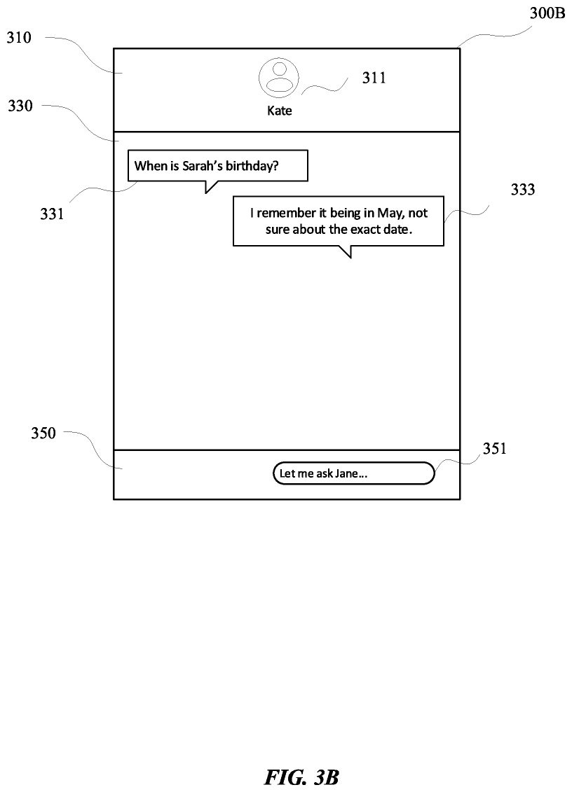

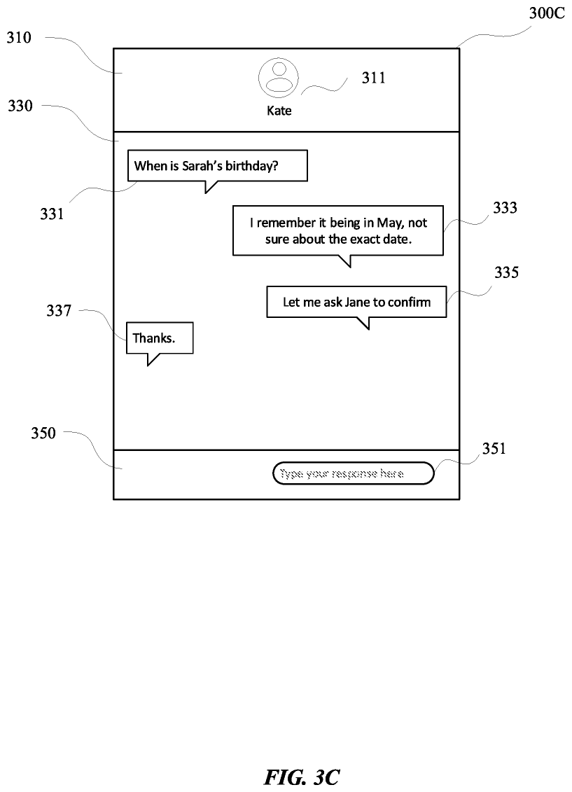

FIG. 3A depicts another example user interface 300A of FIG. 1A or FIG. 1B, in accordance with various implementations. FIG. 3B depicts an example user interface 300B transitioned from the user interface 300A, in accordance with various implementations. FIG. 3C depicts an example user interface 300C transitioned from the user interface 300B, in accordance with various implementations.

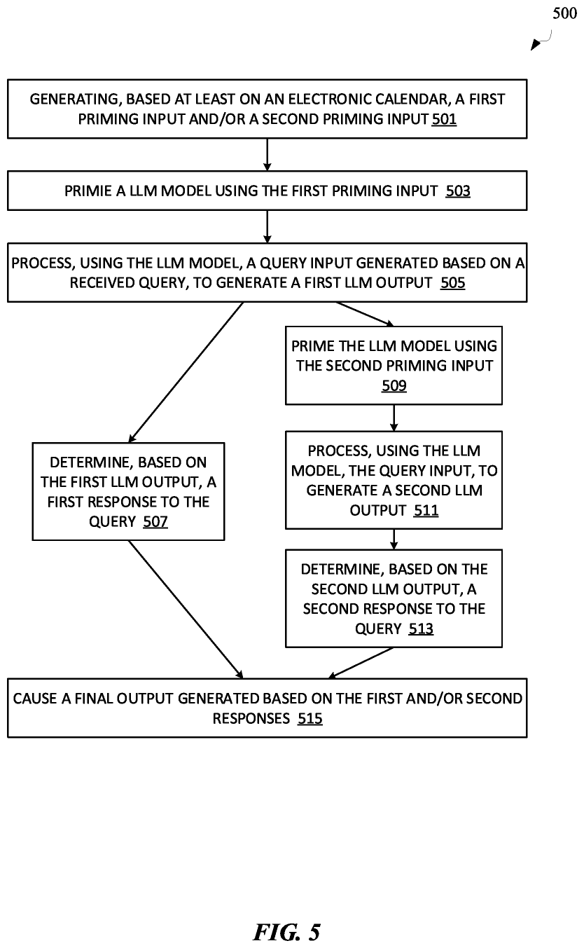

FIG. 5 illustrates another example method 500 for generating selectable response suggestion(s), in accordance with various implementations. For convenience, the operations of the method 500 are described with reference to a system that performs the operations. The system of method 500 includes one or more processors and/or other component(s) of a client device and/or of a server device. Moreover, while operations of the method 500 are shown in a particular order, this is not meant to be limiting. One or more operations may be reordered, omitted, or added.

As shown in FIG. 5, at block 501, the system can generate, based at least on an electronic calendar, a first priming input (and/or a second priming input that is distinct from the first priming input).

In some implementations, the system can process the electronic calendar to generate the first priming input (501) by: processing structured calendar data of an electronic calendar to generate a natural language representation of the structured calendar data of the electronic calendar, and generating the first priming input based on the generated natural language representation of the structured calendar data of the electronic calendar. As a non-limiting example, the electronic calendar can be a calendar of a first user (e.g., a user of a cell phone having a user interface 300A, see FIG. 3A), where the calendar of the first user includes a calendar entry for May 18, 2020, that is titled “Sarah's birthday”. In this example, the structured calendar data (i.e., the calendar entry for May 18, 2020) of the calendar for the first user can be processed to generate a natural language representation (e.g., “Sarah's birthday is May 18th”) of the structured calendar data. Here, the natural language representation (e.g., “Sarah's birthday is May 18th”) can be used as the first priming input, or can be processed or modified to generate the first priming input.

In various implementations, at block 503, the system primes a LLM model using the first priming input, where the first priming input is generated based on the natural language representation (e.g., “Sarah's birthday is May 18th”) of the structured calendar data of the electronic calendar (of the first user). In various implementations, at block 505, the system processes, using the LLM model (which is primed using the first priming input), a query input generated based on a received query, to generate a first LLM output. For example, the LLM model can process a query input (e.g., “find Sarah's birthday in the first user's calendar”) which is generated based on the query (e.g., “When is Sarah's birthday”) received by the first user, to generate the first LLM output such as “May 18, 2020”.

In some implementations, the received query k determined to be relevant to the electronic calendar. For example, referring to FIG. 3A, the first user can receive a text message 331 from a sender 311 (e.g., Molly) via a conversational interface 330 of a user interface 300A of a client device. The text message 331 can includes a query (i.e., “When is Sarah's birthday”), and the query (i.e., “When is Sarah's birthday”) can be determined to be relevant to the calendar of the first user based on any of one or more matching conditions being satisfied. The one or more matching conditions can include, for example, a first matching condition in which the query (e.g., “When is Sarah's birthday”) is matched to the calendar entry (e.g., the calendar entry for May 18, 2020, that is titled “Sarah's birthday”) in the calendar for the first user. The first matching condition can be considered to be satisfied if a matching score for matching the query with the calendar entry of the calendar for the first user exceeds a matching threshold.

Alternatively or additionally, the one or more matching conditions can include, for example, a second matching condition in which the query is processed to determine whether the query includes a noun associated with the calendar of the first user and/or a temporal term. The second matching condition is satisfied if the query is determined to include the noun associated with the calendar of the first user and/or the temporal term. For example, the query (i.e., “When is Sarah's birthday”) can be determined to include a noun indicating a person or a person's name (i.e., “Sarah”) and a temporal term (i.e., “birthday”), so that the second matching condition is determined to be satisfied. In response to the second matching condition being satisfied, a query (i.e., “When is Sarah's birthday”) relevant to the electronic calendar (which includes the calendar entry: “Time: May 18, 2020; Title: Sarah's birthday”) of the first user can be determined to be received.

Optionally, instead of being from the text message 331, the query (e.g., “When is Sarah's birthday”) can be received from a spoken utterance (e.g., “Hi Assistant, when is Sarah's birthday”) of the first user, captured by a microphone of the client device. The spoken utterance can be transmitted to an automated assistant installed at the client device to be processed into natural language content (e.g., “When is Sarah's birthday” in natural language), for example, using the aforementioned ASR engine 131 and/or NW engine 133. The automated assistant can determine, based on the natural language content of the spoken utterance, that the spoken utterance includes a query. The automated assistant can further determine that the query from the spoken utterance is relevant to the electronic calendar of the first user, based on one of the aforementioned matching conditions being satisfied. Repeated descriptions are omitted here.

In various implementations, at block 507, the system uses the first LLM output to determine a first response to the query. For example, referring to FIG. 3A, the first response 333A can be “I believe Sarah's birthday is May 18th”, or “Sarah's birthday is May 18th” (not shown), which is generated by modifying the first LLM output “May 18, 2020” by expanding the first LLM output into a complete sentence and removing redundant (or incorrect) information such as “2020”. Optionally, at block 515, the system causes a final output generated based on the first response to be rendered. For example, referring to FIG. 3A, the final output can include (optionally only include) the first response 333A (e.g., “I believe Sarah's birthday is May 18th”). The first response 333A can be selectable, and when selected, displayed in a text-input field of the conversational interface 330. Optionally, the first response 333A can be displayed as an overlay 333 displayed on top of a portion of the conversational interface 330 (see FIG. 3A), and the first response 333A can disappear if it's not selected by the user to enter the text-input field of the conversational interface 330 (see the conversational interface 330 of the user interface 300B in FIG. 3B that does not display “I believe Sarah's birthday is May 18th”).

In some implementations, continuing with the aforementioned example in which the query (e.g., “When is Sarah's birthday”) is from a spoken utterance (e.g., “Hi Assistant, when is Sarah's birthday”) captured and transmitted to an automated assistant, the final output can be rendered audibly via the automated assistant. In this example, the first response 333A (e.g., “I believe Sarah's birthday is May 18th” in natural language) can be converted using the aforementioned TTS engine 135 of the automated assistant into audio data (e.g., “I believe Sarah's birthday is May 18th” in speech), to be rendered audibly as the final output.

Optionally, referring to FIG. 5, at block 509, the system primes a LLM model using the second priming input. The second priming input can be generated based on the natural language representation of the structured calendar data of the electronic calendar (of the first user), unstructured data, or a combination thereof. As a non-limiting example, the second priming input here can include (or be generated using): (1) the natural language representation (e.g., “Sarah's birthday is May 18th”) of the calendar entry (e.g., “Time: May 18, 2020; Title: Sarah's birthday”) in the electronic calendar of the first user; and (2) unstructured data (e.g., an email) from a source (e.g., an email application) different from the electronic calendar, where the unstructured data can include content such as, Jane sent me an email saying “Sarah's birthday is May 19th, let's prepare a surprise”.

Optionally, in some implementations, referring to FIG. 5, at block 511, the system processes, using the LLM model primed using the second priming input, the query input to generate a second LLM output. Given the same example above, the second priming input here can include: (1) the natural language representation (e.g., “Sarah's birthday is May 18th”); and (2) an email sent by Jane, saying “Sarah's birthday is May 19th, let's prepare a surprise”. In this example, the query input (e.g., “find Sarah's birthday in the first user's calendar”) can be processed using the LLM model primed using the second priming input to generate the second LLM output, such as “May 18th and May 19th”, or “the calendar says Sarah's birthday is May 18th, and the email from Jane says Sarah's birth is May 19th”.

Optionally, in some implementations, referring to FIG. 5, at block 513, the system determines, based on the second LLM output, a second response to the query. As a non-limiting example, given the second LLM output being “the calendar says Sarah's birthday is May 18th, and the email from Jane says Sarah's birth is May 19th”, the second response can be generated, by modifying the second LLM output using one or more techniques described previously, as: “I remember it being in May, not sure about the exact date” (see selectable element 333B in FIG. 3A), “Let me ask Jane” (see selectable element 333C in FIG. 3A), and/or “I believe it's May 18th or May 19th” (not shown in FIG. 3A but can pop up if the user selects a selectable element 333D titled “More options” in FIG. 3A), etc. The selectable element 333C can be displayed along with the selectable element 333A, the selectable element 333B, and/or the selectable element 333D, at the user interface 330A, for receiving user selection.

Optionally, in some implementations, the system can cause the final output generated based on the first response to be rendered (block 515) by: causing the final output generated based on the first and/or second response to be rendered. For example, the second response can include: (1) “I remember it being in May, not sure about the exact date”, and (2) “Let me ask Jane”. Before being rendered, the final output can be generated by combining the second response and the first response, and the final output can be rendered to include a plurality of selectable elements (e.g., 333A˜333C), each selectable element corresponding to the first response (or a portion thereof), or the second response (or a portion thereof).

Optionally, the user interface 330A˜330C can each include a bottom section 350, where the bottom section can receive user input by reminding the user with instructions such as “Type your response here”. For example, the user may select the selectable element 333B to enter the natural language content (i.e., “I remember it being in May, not sure about the exact date”) from the second response as a reply message at the user interface 300B, and may continue to enter more information (e.g., “Let me ask Jane . . . ”) via the manual input field 351 of the bottom section 350 of the user interface 300B. Referring to FIG. 3C, the user may manually enter a follow-up response, i.e., “Let me ask Jane to confirm”, based on the selectable element 333C.

Optionally, the block 509 (i.e., priming a LLM model using a second priming input) can be performed subsequent to block 507 (processing, using the LLM model primed with the first priming input, a query input based on the query). Optionally, the block 509 can be performed prior to the block 507 or prior to the block 505. The present disclosure is not limited thereto, and the orders of the different blocks can be altered or rearranged to improve computing efficiencies and save computing resources depending on the computing circumstance.

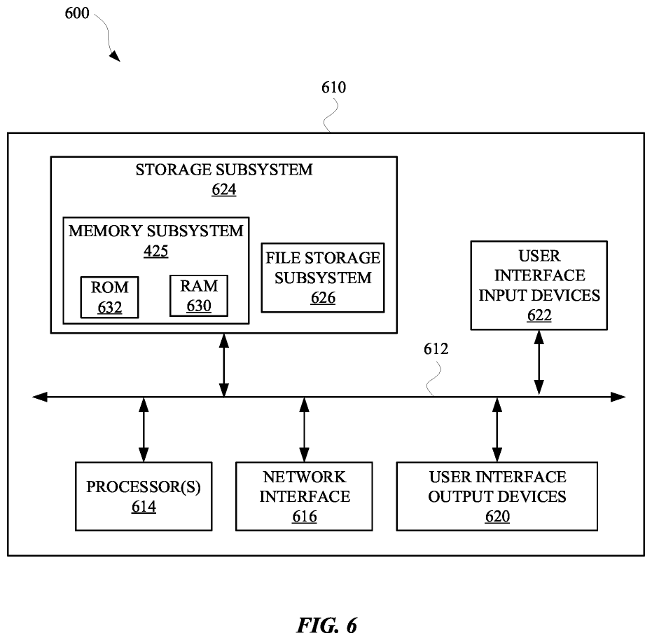

FIG. 6 is a block diagram of an example computing device 610 that may optionally be utilized to perform one or more aspects of techniques described herein. In some implementations, one or more of a client computing device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1 and 2.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple buses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

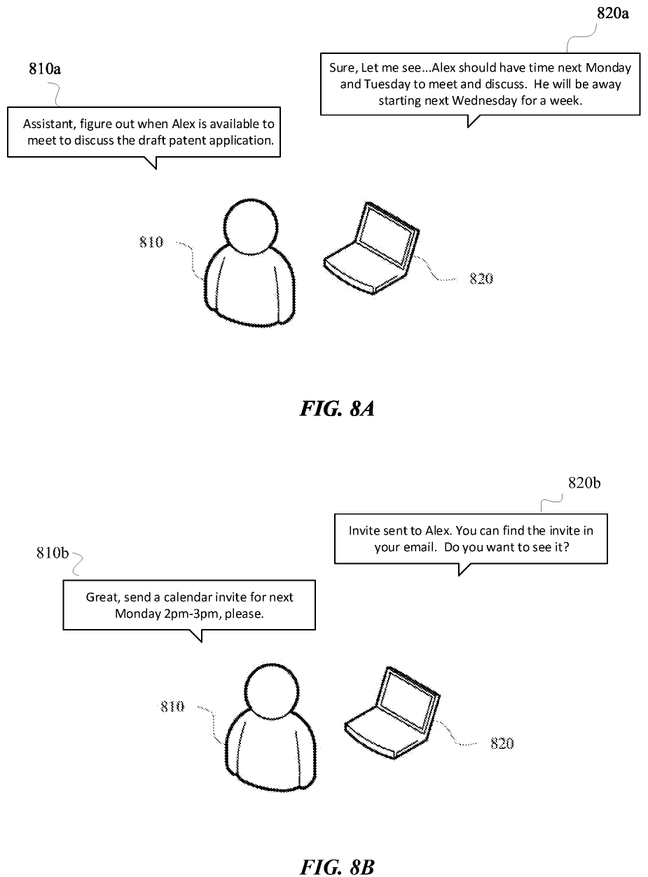

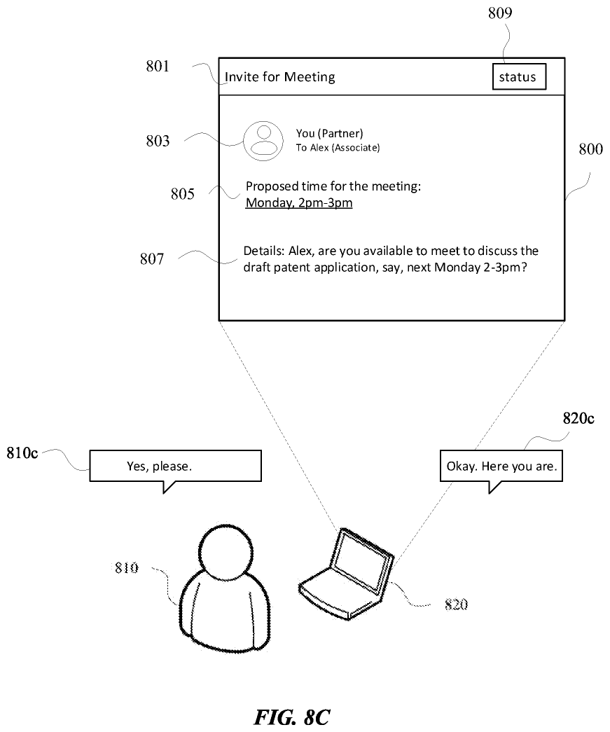

FIGS. 8A, 8B, and 8C together depict another example user interaction involving a query relevant to calendar data, implemented using for example, the computing device 610. As shown in FIG. 8A˜8C, the computing device 610 can be a laptop 820 at which an automated assistant (not shown) is installed. Referring to FIG. 8A, a first user 810 can initiate a conversation with the automated assistant by providing a spoken utterance 810a, e.g., “Assistant, figure out when Alex is available to meet to discuss the draft patent application”. The laptop 820 can capture audio data that contains the spoken utterance 810a and transmit the audio data containing the spoken utterance 810a to the automated assistant, where the automated assistant can process the spoken utterance 810a, and determine that the spoken utterance 810a includes a query relevant to an electronic calendar of a second user named “Alex” (and/or relevant to an electronic calendar of the first user 810). As a non-limiting example, the automated assistant, in response to determining that the spoken utterance 810a includes a query (e.g., “when Alex is available to meet?”) relevant to an electronic calendar of the second user named “Alex”, can process structured calendar data (e.g., Event: out of office; When: August 3 rd/Wednesday to August 9th/Tuesday; Who: Alex; Description: N/A) of the electronic calendar of the second user (i.e., Alex) to generate a natural language representation thereof (e.g., Alex will be out of office next Wednesday until Tuesday August 9 th). The generated natural language representation of the structured calendar data of the electronic calendar of the second user can then be applied to generate a priming input for a LLM, where the LLM is primed using the priming input. After the LLM is primed, a query input (e.g., “when is Alex available based on Alex's electronic calendar?”) that is generated based on the query (e.g., “when Alex is available to meet?”) can be processed using the primed LLM, to generate a LLM output, such as “based on Alex's calendar, he will be away starting next Wednesday for a week”. The automated assistant can further process the LLM output (and/or the spoken utterance 810a) to generate a response 820a, such as, “Alex should have time next Monday and Tuesday to meet and discuss. He will be away starting next Wednesday for a week.”

Optionally, referring to FIG. 8B, in response to receiving the response 820a, the first user 810 can continue the conversation with the automated assistant by providing an additional spoken utterance 810b (e.g., “Great, send a calendar invite for next Monday 2-3 pm, please”). The automated assistant can process the additional spoken utterance 810b to perform one or more actions, where the one or more actions can include: constructing an invite to the second user named Alex, sending the invite to the second user named Alex via an applicable or designated application, and/or causing an additional response 820b (e.g., Invite sent to Alex. You can find the invite in your email. Do you want to see it?) to be rendered to the first user 810. An example of the invite can be found in FIG. 8C, which will be described later in this disclosure. In some implementations, the additional response 820b can include a confirmation (e.g., “Invite sent to Alex”) that the invite was sent, and can identify the application (e.g., your email) via which the invite was sent. In some implementations, the additional response 820b can further include a suggestion, such as, “Do you want to see the invite itself?”.

Optionally, referring to FIG. 8C, the first user 810 can respond to the additional response 820b by providing a further spoken utterance 810c (e.g., “Yes, please”). In response to receiving the further spoken utterance 810c, the automated assistant can cause a further response 820c to be rendered audibly, and cause the invite 800 to be rendered via a display of the laptop 820. As shown in FIG. 8C, the invite 800 can include a title 801 (“Invite for Meeting”) for the invite 800, and participant's information 803 that includes a requesting user (here, the first user 810, with or without a title or identifier such as “Partner”) and a receiving user (here, the second user named Alex, without or without a title or identifier such as “Associate”). The invite 800 can further includes temporal information 805, such as the proposed time for the meeting. As it is in this example, the proposed time for the meeting is August 1 (Monday), 2 pm-3 pm. Optionally, as shown in FIG. 8C, the content, i.e., August 1 (Monday), 2 pm-3 pm, can be selectable, and when selectable, a calendar entry can be formulated and be entered upon user confirmation. Optionally, the invite 800 can further include a description 807, such as “Alex, are you available to meet to discuss the draft patent application, say, next Monday 2-3 pm?”. The description 807 can be generated by the automated assistant based on previous spoken utterances (e.g., the spoken utterance 810a and the additional spoken utterance 810b) of the first user 810. Optionally, invite 800 can include a status icon 809 indicating whether the invite 800 is accepted by the second user (here, the receiving user Alex). The status icon 809 may be clickable or selectable to send a reminder of the invite 800. It's noted that all the examples in this disclosure are for the purpose of illustration only, and are not intended to be limiting. Different features of the examples can be combined or interchanged, unless they are not combinable nor interchangeable.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

What is claimed is:

1. A method implemented by one or more processors, the method comprising:
processing structured calendar data, of an electronic calendar for a first user, to generate a natural language representation of the structured calendar data for the first user; and
in response to receiving a query determined to be relevant to the electronic calendar for the first user:
priming a large language model (LLM) using a priming input that is based on the natural language representation of the structured calendar data for the first user, wherein priming the LLM using the priming input comprises processing the priming input using the LLM,
following priming of the LLM using at least the priming input:
processing, using the LLM, query input that is based on the query, to generate an LLM output, and
determining, based on the LLM output, a response to the query, wherein the response includes a natural language response; and
causing the response to be rendered.

2. The method of claim 1, wherein the priming input includes: the natural language representation of the structured calendar data for the first user and includes the structured calendar data of the electronic calendar for the first user.

3. The method of claim 1, further comprising:
retrieving unstructured calendar data for the first user, the unstructured calendar data including preference data of the first user indicating a preference for one or more time slots.

4. The method of claim 3, wherein the priming input includes the unstructured calendar data for the first user that indicates the user availability of the first user, and the natural language representation of the structured calendar data for the first user.

5. The method of claim 3, wherein determining, based on the LLM output, the response to the query comprises:
modifying, based on the unstructured calendar data for the first user, the LLM output to determine the response to the query.

6. The method of claim 3, further comprising:
priming the LLM using an additional priming input that is based on the unstructured calendar data for the first user that indicates the user availability of the first user, wherein priming the LLM using the additional priming input comprises processing the additional priming input using the LLM.

7. The method of claim 6, further comprising:
following priming of the LLM using the additional priming input:
processing, using the LLM, the query input that is based on the query, to generate an additional LLM output, and
determining, based on the additional LLM output, an additional response to the query, wherein the additional response includes an additional natural language response.

8. The method of claim 7, wherein causing the response to be rendered comprises:
causing the response and the additional response to be rendered simultaneously.

9. The method of claim 7, wherein causing the response to be rendered comprises:
combining the response with the additional response to generate a combined response, and
causing the combined response to be rendered.

10. The method of claim 3, wherein:
the unstructured calendar data for the first user includes: message data indicating an availability status of the first user over one or more time periods, and preference data indicating one or more preferred time slots of the first user.

11. The method of claim 1, wherein when the natural language response indicates the first user is available over a first time period, the method further comprises:
creating, based on the natural language response, an entry, in the electronic calendar of the first user, that corresponds to the first time period.

12. The method of claim 11, wherein prior to creating the entry in the electronic calendar of the first user, the method further comprises:
requesting authorization to create the entry from the first user.

13. The method of claim 12, wherein requesting authorization to create the entry from the first user comprises:
forwarding the query and content describing the entry to the first user, and
requesting user input from the first user regarding whether to create the entry,
wherein the entry is created in the electronic calendar of the first user in response to the user input from the first user indicating user permission from the first user to create the entry.

14. The method of claim 1, wherein prior to priming the LLM, the method further comprises:
receiving a query;
determining whether the query is relevant to the electronic calendar for the first user, wherein the query is determined to be relevant to the electronic calendar for the first user in response to the query including (1) a noun indicating the first user and (2) at least one temporal keyword; and
priming the LLM in response to determining that the query is relevant to the electronic calendar.

15. The method of claim 1, wherein:
the query is received via a messaging application of a computing device, from a second user different from the first user.

16. The method of claim 15, wherein causing the response to be rendered comprises:
causing a selectable suggestion to be rendered via the messaging application for user selection, the selectable suggestion including the natural language response.

17. The method of claim 1, wherein:
the query is received from the first user, or a third user different from the first user, in a spoken utterance captured via an automated assistant.

18. The method of claim 17, wherein causing the response to be rendered comprises:
causing the natural language response to be rendered audibly via the automated assistant.

19. A method implemented by one or more processors, the method comprising:
processing structured calendar data, of an electronic calendar for a first user, to generate a natural language representation of the structured calendar data for the first user; and
in response to receiving a query via an automated assistant and in response to the query being determined to be relevant to the electronic calendar for the first user:
priming a large language model (LLM) using a priming input that is based on the natural language representation of the structured calendar data for the first user, wherein priming the LLM using the priming input comprises processing the priming input using the LLM,
following priming of the LLM using at least the priming input:
processing, using the LLM, query input that is based on the query, to generate a LLM output, and
determining, based on the LLM output, a response to the query, wherein the response includes a natural language response; and
causing the response to be rendered via the automated assistant.

20. A method implemented by one or more processors, the method comprising:
processing structured calendar data, of one or more electronic calendars, to generate a natural language representation of the structured calendar data for each electronic calendar;
receiving a query;
determining whether the query is related to the one or more electronic calendars; and
in response to determining that the query is related to a first electronic calendar of the one or more electronic calendars:
priming a large language model (LLM) using a priming input that is based on the natural language representation of the structured calendar data for the first electronic calendar, wherein priming the LLM using the priming input comprises processing the priming input using the LLM,
following priming of the LLM using at least the priming input:
processing, using the LLM, query input that is based on the query, to generate a LLM output, and
determining, based on the LLM output, a response to the query, wherein the response includes a natural language response; and
causing the response to be rendered.
